(19) United States
(12) Patent Application Publication
(10) Pub. No.: US 2017/0362459 A1
(43) Pub. Date: Dec. 21, 2017

(54) POLYMERIC MATERIALS WITH NEGATIVE PHOTOELASTIC CONSTANTS

(71) Applicants: Rohm and Haas Electronic Materials LLC, Marlborough, MA (US); Dow Global Technologies LLC, Midland, MI (US)

(72) Inventors: Praveen Agarwal, Lake Jackson, TX (US); Justice Alaboson, Lake Jackson, TX (US); Shih-Wei Chang, Natick, MA (US); John W. Lyons, Midland, MI (US); Kathleen M. O'Connell, Cumberland, RI (US); Caroline Woelfle-Gupta, Midland, MI (US); Weijun Zhou, Sugar Land, TX (US)

(21) Appl. No.: 15/534,094

(22) PCT Filed: Dec. 7, 2015
(86) PCT No.: PCT/US15/64204

§ 371 Date: Jun. 8, 2017

Related U.S. Application Data
(60) Provisional application No. 62/093,527, filed on Dec. 18, 2014.

(51) Int. Cl. C09D 139/08; C08K 5/095; C08K 5/00; C08K 5/06; G02F 1/13363; C09D 133/12

(52) U.S. Cl. CPC C09D 139/08; G02F 1/13363; C09D 133/12; C08K 5/0016; C08K 5/06; C08K 5/095

(57) ABSTRACT

A polymeric material having a negative photoelastic constant. The polymeric material comprises: (a) a polymer comprising polymerized units of 2-vinylpyridine, 4-vinylpyridine, methyl methacrylate or a combination thereof; (b) a C₉-C₂₅ aliphatic polycyclic compound; and (c) an organic compound having a boiling point of at least 200° C.

### FIELD OF THE INVENTION

The present invention relates to a polymeric material having a negative photoelastic constant.

### BACKGROUND OF THE INVENTION

An LCD device comprises an LC (liquid crystal) cell formed by arranging a pair of transparent substrates where transparent electrodes are provided so as to face each other, followed by enclosing liquid crystals between the pair of substrates. LCD devices have been widely used in portable telephones, portable information terminals, etc., where enhancement of luminance and improvement of image display quality are desired, as well as making the LCD device lighter and thinner. LCD devices such as smart phones and tablet computers are prone to light leakage, especially around corners and edges, when those devices are used in completely dark state. One important contributing cause is suspected to be stress induced birefringence in the thin glass of the LC cell. Portions of a liquid crystal display can experience stresses due to mounting structures that are attached to the display or due to internal display structures. Glass in general has a positive photoelastic constant, or Cp. Therefore to compensate for stress-induced birefringence of the glass substrates, a material with a negative Cp value is needed as a compensation film. However, few materials are known to have a negative Cp value and no principle for designing a material with negative photo-elastic property is known. There have been a few studies in the literature to examine the effect of plasticizers on Cp, e.g., J. H. Lamble, et al., Brit. J. Appl. Phys., vol. 9, 388. However, this reference teaches only a positive change in Cp due to the incorporation of plasticizers.

### SUMMARY OF THE INVENTION

The present invention provides a polymeric material comprising: (a) a polymer comprising polymerized units of 2-vinylpyridine, 4-vinylpyridine, methyl methacrylate or a combination thereof; (b) a C₉-C₂₅ aliphatic polycyclic compound; and (c) an organic compound having a boiling point of at least 200° C. which is liquid at 100° C., wherein said organic compound is not a C₉-C₂₅ aliphatic polycyclic compound.

The present invention further provides a polymeric material comprising: (a) a polymer comprising polymerized units of 2-vinylpyridine, 4-vinylpyridine, methyl methacrylate or a combination thereof; (b) a compound of formula (II);

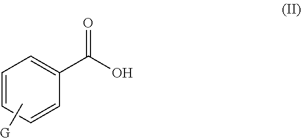

wherein G represents 1-5 substituents selected from the group consisting of fluoro and chloro; and (c) an organic compound having a boiling point of at least 200° C. which is liquid at 100° C., wherein said organic compound is not a compound of formula (II).

The present invention further provides a polymeric material comprising: (a) a polymer comprising polymerized units of 2-vinylpyridine, 4-vinylpyridine, methyl methacrylate or a combination thereof; (b) a mono-, di- or tri-saccharide having from four to eleven aromatic ester substituents; and (c) an organic compound having a boiling point of at least 200° C. which is liquid at 100° C.

The present invention further provides a polymeric material comprising: (a) a polymer comprising polymerized units of 2-vinylpyridine, 4-vinylpyridine, methyl methacrylate or a combination thereof; (b) a compound of formula (III);

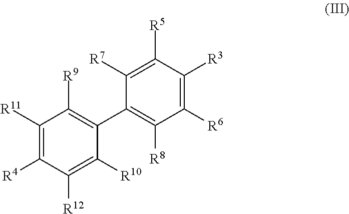

wherein R³ and R⁴ independently represent hydrogen or C₁-C₆ alkyl; R⁵, R⁶, R⁷, R⁸, R⁹, R¹⁰, R¹¹ and R¹² independently represent hydrogen, hydroxyl, cyano, halo, C(O)R¹³ or C(O)OR¹³ where R¹³ is C₁-C₆ alkyl, provided that at least one of R⁵, R⁶, R⁷, R⁸, R⁹, R¹⁰, R¹¹ and R¹² is not hydrogen; and (c) an organic compound having a boiling point of at least 200° C. which is liquid at 100° C.

### DETAILED DESCRIPTION OF THE INVENTION

Percentages are weight percentages (wt %) and temperatures are in ° C., unless specified otherwise. Operations were performed at room temperature (20-25° C.), unless specified otherwise. Boiling points are measured at atmospheric pressure (101 kPa). An organic compound is a compound comprising carbon and hydrogen atoms. Preferably, organic compounds comprise carbon, hydrogen and oxygen atoms. An organic solvent is a compound comprising carbon and hydrogen atoms, and which is liquid at 20° C.

The photo-elastic effect induced birefringence is determined by the photo-elastic constant of the material (Cp) and the amount of stress applied to the material (σ). The photo-elastic constant is determined by calculating the ratio of stress-induced birefringence and the magnitude of the applied stress onto the glassy material under the condition that the applied stress only induces a small degree of elastic deformation in the material. Photo-elastic birefringence of a material is different from intrinsic birefringence (Δn₀) of that material. Intrinsic birefringence refers to the amount of birefringence a material exhibits when it is fully oriented in one direction, for example, by uniaxially stretching the material in one direction. Materials of positive intrinsic birefringence have a refractive index in the x-direction (nₓ), along which the material is fully oriented, larger than the refractive indices n_{y} and n_{z} in the other two directions, y and z, where x, y, z represent three distinct directions that are mutually orthogonal to each other. Conversely, materials of negative intrinsic birefringence have a refractive index in the x-direction, along which the material is fully oriented, smaller than the refractive indices in the other two directions, y and z. Materials of positive intrinsic birefringence type always tend to be of the positive photo-elastic type, whereas for materials of negative birefringence type, they may be either of negative photo-elasticity type or positive photo-elasticity type.

The photo-elastic constant is an intrinsic property of each material and may have a positive or negative value. Thus, materials are divided into two groups: a group having a positive photo-elastic constant and the other group having a negative photo-elastic constant. Materials with a positive photo-elastic constant tend to exhibit positive birefringence (i.e., nx>ny) when the material in subject to small degree of uni-axial tensile stress along the x-direction. Conversely, materials with a negative photo-elastic constant will exhibit negative birefringence (i.e., nx<ny) when the material is subject to a small degree of uni-axial tensile stress along the x-direction.

Retardation is a measure of birefringence in a sheet of material. It is defined as the product of Δn and the thickness of the sheet, where Δn is the absolute value of the difference between nₓ and n_{y}.

Preferably, the C₉-C₂₅ aliphatic polycyclic compound contains only carbon, hydrogen and oxygen atoms; preferably no more than six oxygen atoms, preferably no more than four. Preferably, the C₉-C₂₅ aliphatic polycyclic compound is a bridged polycyclic compound; preferably a bicyclic, tricyclic or tetracyclic compound; these compounds may be substituted with alkyl, alkoxy or hydroxy groups; preferably methyl and/or hydroxy groups; or they may be unsubstituted. Preferably, the aliphatic polycyclic compound has from 10 to 20 carbon atoms. Preferably, the C₉-C₂₅ aliphatic polycyclic compound comprises a C₆-C₂₀ aliphatic polycyclic substituent bonded to a C₂-C₈ acyclic aliphatic substituent. Preferably, the C₂-C₈ acyclic aliphatic substituent comprises from one to four oxygen atoms; preferably at least two, preferably no more than three. Preferably, the acyclic aliphatic substituent has from three to six carbon atoms. Preferably, the acyclic aliphatic substituent has at least one ester group. Preferably, the aliphatic polycyclic substituent is bonded to the acyclic aliphatic substituent through an ester oxygen. Preferably, the aliphatic polycyclic substituent has from 8 to 12 carbon atoms. Preferably, the aliphatic polycyclic substituent is a bridged polycyclic substituent, preferably a bicyclic, tricyclic or tetracyclic substituent. Preferably, the C₉-C₂₅ aliphatic polycyclic compound is a compound of formula (I)

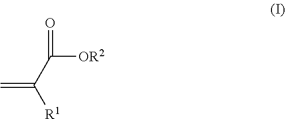

wherein R¹ is hydrogen or methyl and R² is a C₆-C₂₀ aliphatic polycyclic substituent which is unsubstituted or has an acrylate or methacrylate ester substituent. Preferably, R² is a C₇-C₁₅ aliphatic polycyclic substituent, preferably R² is a C₈-C₁₂ aliphatic polycyclic substituent. Preferably, R² is a bridged polycyclic substituent; preferably a bicyclic, tricyclic or tetracyclic substituent. Preferred structures for R² include, e.g., adamantanes, bicyclo[2,2,1]alkanes, bicyclo[2,2,2]alkanes, bicyclo[2,1,1]alkanes; these structures may be substituted with alkyl, alkoxy or hydroxy groups; preferably methyl and/or hydroxy groups. Adamantanes and bicyclo[2,2,1]alkanes are especially preferred. Preferably, R¹ is methyl. Preferably, R² is unsubstituted.

Preferably, G in formula (II) represents two to four substituents, preferably two or three, preferably three. Preferably, G represents fluoro or chloro, preferably fluoro.

Preferably, the mono-, di- or tri-saccharide having from four to eleven aromatic ester substituents is a mono- or di-saccharide, preferably a di-saccharide. Preferably, a mono- or di-saccharide has from three to eight aromatic ester substituents, preferably from five to eight, preferably from six to eight. Preferably, a mono-saccharide has three or four aromatic ester substituents, preferably four. Preferably, the aromatic ester substituents have from 7 to 20 carbon atoms, preferably from 7 to 15, preferably from 7 to 10. Preferably, the aromatic ester substituents are benzoate ester substituents, which may be substituted or unsubstituted; substituted benzoates may be substituted by C₁-C₄ alkyl groups, hydroxyl groups or C₁-C₄ alkoxy groups.

Preferably, R³ and R⁴ independently represent hydrogen or C₁-C₄ alkyl; preferably hydrogen, methyl or ethyl; preferably hydrogen or methyl. Preferably, R⁵, R⁶, R⁷, R⁸, R⁹, R¹⁰, R¹¹ and R¹² independently represent hydrogen, hydroxyl or cyano.

Preferably, the copolymer is prepared by free radical solution polymerization. Weight average molecular weight (Mw) of copolymers is larger than 50,000 g/mole, preferably larger than 75,000 g/mole, even more preferably greater than 100,000 g/mole, all based on polystyrene equivalent molecular weight. Copolymers with Mw less than 50,000 g/mole are too brittle to be practically useful for many of the optical applications.

Preferably, the organic compound having a boiling point of at least 200° C. contains only carbon, hydrogen and oxygen atoms. Preferably, the organic compound is an aliphatic ether or ester. Preferably, the aliphatic ether has at least one hydroxyl group, preferably one or two. Preferably, the organic compound has from 4 to 40 carbon atoms; preferably at least 5, preferably at least 6; preferably at least 7; preferably no more than 35, preferably no more than 30, preferably no more than 25, preferably no more than 20, preferably no more than 15. Preferably, when the organic compound has more than 20 carbon atoms, it also has more than 10 oxygen atoms; preferably at least 8 oxygen atoms are present in ether linkages; preferably the organic compound is an oligomer of ethylene glycol. When the aliphatic ether is an oligomer, e.g., of ethylene glycol, the number of carbon atoms is the number average in the oligomer. Preferably, an aliphatic ether has from 2 to 12 oxygen atoms, preferably from 2 to 10, preferably from 3 to 6, which may be present as ether oxygens, ester oxygens or hydroxyl groups. Especially preferred organic compounds include tri-n-butyl citrate TnBC, hexyl carbitol, hexyl cellosolve, triethylene glycol (TEG), tetraethylene glycol and polyethylene glycol having a number average molecular weight from 200 to 800 (e.g., CARBOWAX polyethylene glycols). Preferably, the organic compound has a boiling point of at least 200° C.; preferably no greater than 350° C., preferably no greater than 320° C. Preferably, the organic compound is liquid at 80° C., preferably at 60° C., preferably at 40° C., preferably at 30° C. Preferably, the amount of organic compound in the polymeric material is at least 3 wt %, preferably at least 4 wt %, preferably at least 5 wt %, preferably at least 6 wt %, preferably at least 7 wt %; preferably no more than 12 wt %, preferably no more than 11 wt %, preferably no more than 10 wt %, preferably no more than 9 wt %. Preferably the amount of copolymer in the polymeric material is at least 70 wt %, preferably at least 75 wt %, preferably at least 80 wt %; preferably no more than 97 wt %, preferably no more than 96 wt %, preferably no more than 95 wt %, preferably no more than 94 wt %, preferably no more than 93 wt %. In one preferred embodiment of the invention, the organic compound is an organic solvent.

Preferably, the polymeric material is prepared by blending the copolymer and an additive molecule (i.e., component (b)) with a polar, low-boiling solvent and the aforementioned organic compound(s) having a boiling point of at least 200° C. Preferably, the low-boiling solvent has a boiling point from 35 to 140° C., preferably from 45 to 120° C., preferably from 50 to 110° C. Preferably, the low-boiling solvent is an alcohol, an ester or a ketone Preferred low-boiling solvents include ethanol, 1-butanol, cyclopentanone and ethyl lactate. Preferably, the mixture of copolymer, additive molecule and solvents (low-boiling solvent and organic compound having bp>200° C.) comprises from 2 to 20 wt % of the organic compound having a boiling point of at least 200° C. and from 30 to 75 wt % of the low-boiling solvent preferably from 3 to 10 wt % of the organic solvent having a boiling point of at least 200° C. and from 35 to 70 wt % of the low-boiling solvent Preferably, after casting the wet film is dried, preferably at a temperature from 50 to 120° C.

Preferably, for at least part of the drying time the wet film is under vacuum to facilitate removal of the low-boiling solvent. Preferably, at least 90% of the original amount of low-boiling solvent is removed, preferably at least 95%, preferably at least 98%, preferably at least 99%.

The mixture of copolymer and solvents may be coated onto a glass substrate (e.g., the surface of a liquid crystal display (LCD) cell) to suppress light leakage by using any suitable coating processes well known in the art. For example, the polymeric material may be coated onto glass by dip coating, spin coating or slot die coating. A slot die coating process is more preferable with its relatively easy control of coating area, coating thickness and uniformity. The preferable range of the thickness of the polymeric material layer is less than 100 μm, preferably less than 50 μm, preferably less than 25 μm.; preferably larger than 1 μm, preferably larger than 5 μm, even more preferably larger than 10 μm. When the thickness of such polymeric material is greater than 100 μm, it is not desirable as consumers prefer thinner electronic devices. Conversely, when the thickness of coating is less than 1 μm, their effect to optically compensate glass birefringence under stress is very limited.

The preferred range of the thickness of the glass sheet is from 0.1 mm to 0.7 mm, preferably from 0.2 mm to 0.5 mm. When the thickness of the glass substrate is greater than 0.7 mm, the effect of optical coating may not be strong enough and this will also increase the thickness of the device. When the glass substrate is less than 0.1 mm, its physical rigidity becomes problematic for device fabrication.

### Examples

Poly(2-vinylpyridine), poly(4-vinylpyridine), tri-n butyl citrate (TnBC), tri-phenyl phosphate, diethyl phthalate, dihexyl phthalate, di(2-ethyl hexyl) phthalate, dicyclohexyl phthalate, di(2-ethyl hexyl) sebacate, di(2-ethyl hexyl) azelate, dimethyl azelate, diisodecyl adipate, di(2-ethyl hexyl) maleate were obtained from Scientific Polymer Products. 3-hydroxy-1-adamantyl methacrylate (HAMA) was obtained from Idemitsu. Isobomyl methacrylate (IBOMA), 1-butanol, ethyl lactate, cyclohexanone, cyclopentanone, methanol, ethanol (EtOH), propylene glycol methyl ether acetate (PGMEA) were purchased from Sigma-Aldrich. 1-methoxy-2-propanol (PGME), hexyl cellosolve, hexyl carbitol, triethylene glycol were obtained from The Dow Chemical Company.

Films were prepared by solution casting on a release paper on a glass substrate with a drawdown bar using a byko-drive Automatic Film Applicator, with a typical draw down speed of 10 mm/sec. Bar clearance was adjusted for different formulations based on their wt % solids and the target dry film thickness. For preparation of freestanding film samples, liquid formulation coatings were drawn down on Warren Universal Patent release papers and the films were released after the coating was completely dried.

Two sets of composite films comprising 80 wt % poly(2-vinylpyridine) (P2VP) and 20 wt % HAMA (1-hydroxy-3-adamantyl methacrylate) were prepared from cyclopentanone and 1-butanol as casting solvents. Films were prepared by drawing a 24 mil thick solution on a 2×6 inch (5.1×15.2 cm) and 0.5 mm thickness glass plate pre-treated with PDMS-brush polymer (source of the material). One set of the materials was baked at 75 deg C. under vacuum for 19 hrs, and the other set was subject to additional baking at 95 deg C. for 72 hrs for further removal of residual solvents in the film samples.

Photo-elastic property measurements were conducted on dry film specimens of approximately 1″×3″ (2.54×7.62 cm) size. Film specimens were mounted on a custom made uniaxial tensile stretching stage that is attached to EXICOR 150 AT birefringence measurement systems (Hinds Instruments). Optical retardation of the films as a function of the uniaxial stretching force was measured near the middle section of the film at the wavelength of 546 nanometer (nm) while the film was simultaneous stretched. Force was controlled manually and recorded by a force transducer (OMEGA DFG41-RS) connected to one of the sample mounting grips. The maximum force applied to testing specimens was approximately 10-15 Newtons. Film birefringence was obtained by dividing the measured retardation to the film thickness. Photoelasticity constant or stress optic coefficient, Cp, is equal to the slope determined from linear fitting the measured birefringence as a function of uniaxial tensile stress, and reported in units of Pa⁻¹. The results are shown below (Brewster units are used throughout the Examples; 1 Br=10⁻¹² Pa⁻¹). Upon the removal of residual solvent in film, the Cp value of this P2VP-HAMA film was found to approach that of neat P2VP at about 8.4 Brewster units.

| Solvent | Baking conditions | Cp (Brewster units) |
|---|---|---|
| cyclopentanone | 75° C., 19 hr | −67 |
| | 75° C., 19 hr; 92° C., 72 hr | −12 |
| 1-butanol | 75° C., 19 hr | −41 |
| | 75° C., 19 hr; 92° C., 72 hr | +5.2 |

The observed change of photo-elastic property from negative towards positive after thermal heat aging is undesirable. However, incorporation of an organic compound with a higher boiling point was found to be surprisingly effective for maintaining the large negative Cp property of the materials after baking at elevated temperatures. The solvent system comprises a low boiling point, high relative evaporation rate (RER) majority solvent for easier solvent removal, and a high boiling point, low RER minority solvent that will largely remain in the final film. Ethanol, which has a boiling point of 78° C. d and an RER of 150 (relative to n-butyl acetate), was used as the majority solvent. Three high boiling point solvents: hexyl cellosolve (ethylene glycol mono n-hexyl ether), hexyl carbitol (diethylene glycol mono n-hexyl ether), and triethylene glycol, were used as the minority solvent.

Freestanding films were prepared using a drawdown bar coater using a 24 mil bar (theoretical FT of 106 um). The films were baked at 75° C. overnight followed by a 95° C. bake for 3 additional hours under vacuum for removal of the ethanol co-solvent. The photoelastic constant, or Cp, was measured for P2VP-20 wt % HAMA films prepared in the solvent systems including a high-boiling solvent. As a reference point, P2VP-20 wt % HAMA cast from pure ethanol has a Cp of +8.42 Br, a value very close to that of neat P2VP. Cp of the 3-component systems are tabulated below both as a function of the composite film Tg and as a function of the amount of residual solvent in film (determined by thermogravimetric analysis). Incorporation of triethylene glycol (TEG) led to the greatest reduction in the Cp at −597.57 Br.

### Ex 1-5 and CompEx C1

(note: Data in Table 1 demonstrates the effect of incorporating a high boiler TEG as a polymer modifier on photo-elastic property and Tg of P2VP polymer)

TABLE 1
Examples of formulations with and without a polymer
modifier on photoelastic property of P2VP polymer

| Ex/ | | | Component B | | Component C | | | Cp | |
|---|---|---|---|---|---|---|---|---|---|
| Comp | Component A | | Additive | | polymer | | ethanol | (×10⁻¹² | Tg |
| Ex | polymer | parts | compound | parts | modifier | parts | (parts) | Pa⁻¹) | (° C.) |
| C1 | P2VP | 28 | HAMA | 7 | — | — | 65 | 8.4 | 108.8 |
| 1 | P2VP | 28 | HAMA | 7 | TEG | 0.325 | 64.675 | 7 | 72.9 |
| 2 | P2VP | 28 | HAMA | 7 | TEG | 0.65 | 64.35 | 5.7 | 73.1 |
| 3 | P2VP | 28 | HAMA | 7 | TEG | 1.3 | 63.7 | −10.7 | 70.2 |
| 4 | P2VP | 28 | HAMA | 7 | TEG | 3.25 | 61.75 | −155 | 65.1 |
| 5 | P2VP | 28 | HAMA | 7 | TEG | 6.5 | 58.5 | −598 | 54.7 |

### Ex 6-9 and CompEx C2

Done as shown in Ex 1-5 and C1, but with different base polymer (P4VP). Results are summarized in Table 2, showing that the incorporation of a polymer modifier TEG results in a film with negative photo-elastic property.

TABLE 2
Examples of formulations with and without a polymer
modifier on photoelastic property of P4VP polymer

| Ex/ | | | Component B | | Component C | | | Cp | |
|---|---|---|---|---|---|---|---|---|---|
| Comp | Component A | | additive | | polymer | | ethanol | (×10⁻¹² | Tg |
| Ex | polymer | parts | compound | parts | modifier | parts | (parts) | Pa⁻¹) | (° C.) |
| C2 | P4VP | 28 | HAMA | 7 | — | — | 65 | 6.9 | 108.8 |
| 6 | P4VP | 28 | HAMA | 7 | TEG | 0.325 | 64.675 | 4.1 | 107.2 |
| 7 | P4VP | 28 | HAMA | 7 | TEG | 0.65 | 64.35 | nm | 102.6 |
| 8 | P4VP | 28 | HAMA | 7 | TEG | 1.3 | 63.7 | −5.9 | 100.0 |
| 9 | P4VP | 28 | HAMA | 7 | TEG | 3.25 | 61.75 | −118.8 | 76.5 |

### Ex 10-11 and Comp Ex C3 to C8

Done as shown in Ex 1-5 and C1, but with different base polymer (P4VP) and polymer modifier. Results are summarized in Table 3, showing that the incorporation of a polymer modifier and photo-elastic (PE) additive can result in the negative photo-elastic performance in S-r-2VP copolymer, S-r-MMA copolymer, but not in PMMA homopolymer, suggesting base polymers preferably need to have a large chromophore such as benzene or pyridine ring hanging on the side group of polymer chains.

TABLE 3
Examples of formulations with and without a polymer
modifier on photoelastic property of various polymers

| Ex/ | | | Component B | | Component C | | | cast | Cp |
|---|---|---|---|---|---|---|---|---|---|
| Comp | Component A | | additive | | polymer | | cast | solvent | (×10⁻¹² |
| Ex | polymer | parts | compound | parts | modifier | parts | solvent | parts | Pa⁻¹) |
| C3 | S-r-2VP | 35 | — | — | — | — | cyclopentanone | 65 | 8.8 |
| C4 | S-r-2VP | 28 | HAMA | 7 | — | — | cyclopentanone | 65 | 8.5 |
| 10 | S-r-2VP | 28 | HAMA | 7 | TnBC | 13 | cyclopentanone | 52 | −2.8 |
| C5 | S-r- | 35 | — | — | — | — | anisole | 65 | NM |
| | MMA | | | | | | | | |
| 11 | S-r- | 28 | HAMA | 7 | TnBC | 13 | anisole | 52 | −34.3 |
| | MMA | | | | | | | | |
| C6 | PMMA | 35 | — | — | — | — | anisole | 65 | 2.6 |
| C7 | PMMA | 28 | HAMA | 7 | — | — | anisole | 65 | 0.6 |
| C8 | PMMA | 28 | HAMA | 7 | DHP | 13 | anisole | 52 | 2.9 |

This result indicates that by properly picking the constituent ratios, the Cp and Tg performance, of the composite system can be tuned. The flexibility in formulation provided by the 3-component system allows for a large design space to find the right balance between large negative Cp and good thermal stability at elevated temperatures.

Other compounds and solvents were incorporated into films as shown in the tables below:

| poly. | wt % | additive compound | wt % | solvents | | Cp |
|---|---|---|---|---|---|---|
| P2VP | 90 | 4-methyl-2-biphenylcarbonitrile | 10 | EtOH/TEG (95:5) | RT 3 hr−> | −17.1 |
| P2VP | 90 | 3-phenyl phenol | 10 | EtOH/TEG (95:5) | 50 C. 10 min−> | −25.4 |
| P2VP | 90 | HADA¹ | 10 | EtOH/TEG (95:5) | vacuum bake | −37.5 |
| P2VP | 90 | trans-stilbene | 10 | Anisole/TEG (95:5) | 75 C. | 19.4 |
| P2VP | 90 | N-phthalcyl-L-glutamic acid | 10 | EtOH/Carbowax 400 (95:5) | overnight−> | 10.4 |
| P2VP | 90 | Ethylene glycol | 10 | EtOH/Carbowax 400 (95:5) | vacuum bake | −47.2 |
| | | dicyclopentenyl ether acrylate | | | 95 C. 3 h | |
| P2VP | 90 | tricyclo[5,2,1,0^{2,6}]decane | 10 | EtOH/Carbowax 400 (95:5) | | −5.8 |
| | | dimethanol diacrylate | | | | |
| P2VP | 90 | 3,4,5-trifluorobenzoic acid | 10 | EtOH/Carbowax 400 (95:5) | | −60 |
| P4VP | 95 | HAMA | 5 | EtOH/TEG = 95:5 | RT 3 hr−> | 3.6 |
| P4VP | 85 | HAMA | 15 | EtOH/TEG = 95:5 | 50 C. 10 min−> | −7.7 |
| P4VP | 80 | HAMA | 20 | EtOH/TEG = 95:5 | vacuum bake | −76.3 |
| P4VP | 75 | HAMA | 25 | EtOH/TEG = 95:5 | 75 C. | −133.0 |
| | | | | | overnight−> | |
| | | | | | vacuum bake | |
| | | | | | 95 C. 3 h | |

1. 1-hydroxy-3-adamantyl acrylate
For all samples in this table polymer+additive=35 parts and total solvents=65 parts

| | | | | | | | cast | |
|---|---|---|---|---|---|---|---|---|
| | | Component B | | Component C | | | solvent | Cp |
| Component A | | Additive | | polymer | | cast | amount | (×10⁻¹² |
| poly. | parts | compound | parts | modifier | parts | solvent | (parts) | Pa⁻¹) |
| P2VP | 31.5 | sucrose benzoate | 3.5 | CW400 | 5 | ethanol | 60 | 14.3 |
| P2VP | 31.5 | sucrose benzoate | 3.5 | CW400 | 10 | ethanol | 55 | −197.5 |

“sucrose benzoate” is sucrose with eight benzoate substituents

CW=CARBOWAX polyethylene glycol; Hex Carb=hexyl carbitol; Hex Cell=hexyl cellosolve

1. A polymeric material comprising: (a) a polymer comprising polymerized units of 2-vinylpyridine, 4-vinylpyridine, methyl methacrylate or a combination thereof; (b) a C₉-C₂₅ aliphatic polycyclic compound; and (c) an organic compound having a boiling point of at least 200° C. which is liquid at 100° C.

2. The polymeric material of claim 1 in which R² is a bridged polycyclic substituent.

3. A polymeric material comprising: (a) a polymer comprising polymerized units of 2-vinylpyridine, 4-vinylpyridine, methyl methacrylate or a combination thereof; (b) a compound of formula (II); 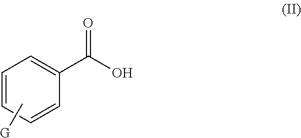
wherein G represents 1-5 substituents selected from the group consisting of fluoro and chloro; and (c) an organic compound having a boiling point of at least 200° C. which is liquid at 100° C., wherein said organic compound is not a compound of formula (II).

4. The polymeric material of claim 3 in which G represents fluoro.

5. A polymeric material comprising: (a) a polymer comprising polymerized units of 2-vinylpyridine, 4-vinylpyridine, methyl methacrylate or a combination thereof; (b) a mono-, di- or tri-saccharide having from four to eleven aromatic ester substituents; and (c) an organic solvent having a boiling point of at least 200° C. which is liquid at 100° C.

6. The polymeric material of claim 5 in which component (b) is a disaccharide.

7. The polymeric material of claim 2 in which the copolymer comprises polymerized units of from 75 to 85 wt % of 2-vinylpyridine and from 15 to 25 wt % of the compound of formula (I).

8. The polymeric material of claim 7 in which the organic solvent is an aliphatic ether having from 5 to 15 carbon atoms and from 2 to 5 oxygen atoms.

9. A method for producing a polymeric material having a negative photoelastic constant;
said polymeric material comprising: (a) a polymer comprising polymerized units of 2-vinylpyridine, 4-vinylpyridine, methyl methacrylate or a combination thereof; (b) a C₉-C₂₅ aliphatic polycyclic compound; and (c) an organic compound having a boiling point of at least 200° C. which is liquid at 100° C.; said method comprising steps of: (i) blending said polymer and said C₉-C₂₅ aliphatic polycyclic compound with a first solvent having a boiling point from 35 to 140° C. and the aforementioned organic solvent having a boiling point of at least 200° C. to produce a wet polymeric material; (b) coating said wet polymeric material on a glass substrate; and (c) heating to a temperature from 50 to 120° C. to remove at least 90% of the first solvent.
